(19) United States
(12) Patent Application Publication
(10) Pub. No.: US 2004/0136022 A1
(43) Pub. Date: Jul. 15, 2004

(54) Image-forming apparatus and image data transfer method

(76) Inventors: Osamu Kizaki, Saitama (JP); Hidenori Shindoh, Tokyo (JP); Kiyotaka Moteki, Tokyo (JP); Takao Okamura, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/694,062

(22) Filed: Oct. 28, 2003

(30) Foreign Application Priority Data
Oct. 29, 2002 (JP) 2002-314674
Oct. 29, 2002 (JP) 2002-314675
Sep. 19, 2003 (JP) 2003-328199

(51) Int. Cl. G06F 15/00; G06F 3/12

(52) U.S. Cl. 358/1.13; 358/1.15

(57) ABSTRACT

An image-forming apparatus with a hardware resource used for image formation, a program for performing processing related to the image formation, and a communication part includes a format information acquisition part, a format determination part, and an image data conversion part. The format information acquisition part acquires format information from an apparatus connected to the image-forming apparatus via the communication part. The format information includes information on a format of image data supportable by the connected apparatus. The format determination part determines the transfer-time format of image data to be transferred to the connected apparatus based on the acquired format information. The image data conversion part performs format conversion of the image data to be transferred to the connected apparatus in accordance with the determined transfer-time format of the image data.

### BACKGROUND OF THE INVENTION

1. Field of the Invention

The present invention generally relates to image-forming apparatuses and image data transfer methods, and more particularly to an image-forming apparatus transferring or receiving image data and a method of transferring image data between image-forming apparatuses.

2. Description of the Related Art

Facsimile machines are typical of those transferring image data between different apparatuses. Recently, an image-forming apparatus that contains the functions of a variety of apparatuses such as a facsimile machine, a printer, a copier, and a scanner in a single housing has become known. Such an image-forming apparatus is hereinafter referred to as a multi-function apparatus. The multi-function apparatus includes a display part, a printing part, and an image-capturing part in a single housing, and has four types of applications corresponding to a facsimile machine, a printer, a copier, and a scanner. By switching these applications, the multi-function apparatus operates as a facsimile machine, a printer, a copier, and a scanner.

A plurality of multi-function apparatuses may be connected to exchange data therebetween. For instance, when one of the connected multi-function apparatuses makes a large number of copies, the other connected multi-function apparatuses are caused to make copies so that the connected multi-function apparatuses make copies simultaneously.

In the case of transferring image data between facsimile machines or multi-function apparatuses, normally, the image data is transferred between apparatuses of different specifications.

Therefore, in the case of transferring image data from a first facsimile machine to a second facsimile machine, for instance, the first facsimile machine tests the second facsimile machine by modem training so as to determine whether the second facsimile machine complies with the G4 standard, and transfers the image data to the second facsimile machine by the G4 or G3 standard depending on the result of the test.

However, modem training determines only the transmission method, and does not go so far as to determine the image data format, even though a large number of image data formats exist. Accordingly, it has been impossible for not only the facsimile machines but also other conventional apparatuses to determine which of a large number of image data formats a receiver apparatus supports, so that it has been difficult for a transmitter apparatus to transfer image data in accordance with the capability of the receiver apparatus.

### SUMMARY OF THE INVENTION

Accordingly, it is a general object of the present invention to provide an image-forming apparatus and an image data transfer method in which the above-described disadvantage is eliminated.

A more specific object of the present invention is to provide an image-forming apparatus and an image data transfer method that transfer or receive image data in accordance with the capability of a receiver apparatus.

The above objects of the present invention are achieved by an image-forming apparatus with a hardware resource used for image formation, a program for performing processing related to the image formation, and a communication part, the image-forming apparatus including: a format information acquisition part that acquires format information from an apparatus connected to the image-forming apparatus via the communication part, the format information including information on a format of image data supportable by the connected apparatus; a format determination part that determines a transfer-time format of image data to be transferred to the connected apparatus based on the acquired format information; and an image data conversion part that performs format conversion of the image data to be transferred to the connected apparatus in accordance with the determined transfer-time format of the image data.

The above-described image-forming apparatus can transfer image data to an apparatus connected thereto in accordance with the capability of the connected apparatus.

The above objects of the present invention are also achieved by an image-forming apparatus with a hardware resource used for image formation, a program for performing processing related to the image formation, and a communication part, the image-forming apparatus including: a format information generation part that generates format information including a format of image data supportable by the image-forming apparatus; a format information supply part that supplies the generated format information to an apparatus connected to the image-forming apparatus via the communication part; and an image data conversion part that converts image data received from the connected apparatus in accordance with a format of the received image data.

The above-described image-forming apparatus can receive image data from an apparatus connected thereto in accordance with the capability of the image-forming apparatus.

The above objects of the present invention are also achieved by an image data transfer method of an image-forming apparatus with a hardware resource used for image formation, a program for performing processing related to the image formation, and a communication part, the image data transfer method including the steps of: (a) acquiring format information from an apparatus connected to the image-forming apparatus via the communication part, the format information including information on a format of image data supportable by the connected apparatus; (b) determining a transfer-time format of image data to be transferred to the connected apparatus based on the acquired format information; and (c) performing format conversion of the image data to be transferred to the connected apparatus in accordance with the determined transfer-time format of the image data.

According to the above-described image data transfer method, an image-forming apparatus can transfer image data to an apparatus connected thereto in accordance with the capability of the connected apparatus.

The above objects of the present invention are further achieved by a method of transferring image data between first and second image-forming apparatuses connected via a network, the method including the steps of: (a) the first image-forming apparatus generating format information including a format of image data supportable by the first image-forming apparatus; (b) the second image-forming apparatus acquiring the format information from the first image-forming apparatus via the network; (c) the second image-forming apparatus determining a transfer-time format of image data to be transferred to the first image-forming apparatus via the network based on the acquired format information; and (d) the second image-forming apparatus performing format conversion of the image data to be transferred to the first image-forming apparatus via the network in accordance with the determined transfer-time format of the image data.

According to the above-described method, an image-forming apparatus can transfer image data to another image-forming apparatus connected thereto in accordance with the capability of the other image-forming apparatus, and the other image-forming apparatus can receive the image data from the image-forming apparatus in accordance with the capability of the other image-forming apparatus.

### BRIEF DESCRIPTION OF THE DRAWINGS

Other objects, features and advantages of the present invention will become more apparent from the following detailed description when read in conjunction with the accompanying drawings, in which:

FIG. 1 is a block diagram showing a configuration of a multi-function apparatus according to a first embodiment of the present invention;

FIG. 2 is a block diagram showing a hardware configuration of the multi-function apparatus according to the first embodiment of the present invention;

FIG. 3 is a diagram showing the basic contents of an operation according to the first embodiment of the present invention;

FIG. 4 is a diagram showing the multi-function apparatuses connected in compliance with the IEEE 1394 standard according to the first embodiment of the present invention;

FIG. 5 is a diagram showing the multi-function apparatuses connected via the Internet or a LAN according to the first embodiment of the present invention;

FIG. 6 is a diagram showing the flow of image data in the multi-function apparatus and a related configuration thereof according to the first embodiment of the present invention;

FIG. 7 is a table showing formats of image data input from an input part of the multi-function apparatus according to the first embodiment of the present invention;

FIG. 8 is a table showing formats of image data convertible in an MLB of the multi-function apparatus according to the first embodiment of the present invention;

FIG. 9 is a table showing formats of image data storable in an HDD of the multi-function apparatus according to the first embodiment of the present invention;

FIG. 10 is a table showing formats of image data output from an output part of the multi-function apparatus according to the first embodiment of the present invention;

FIG. 11 is a table showing formats of image data transmitted from or received by an external I/F of the multi-function apparatus according to the first embodiment of the present invention;

FIG. 12 is a block diagram for illustrating a software configuration of an SCS of the multi-function apparatus according to the first embodiment of the present invention;

FIG. 13 is a flowchart of the operation of generating and acquiring format information according to the first embodiment of the present invention;

FIG. 14 shows an MLB image format table according to the first embodiment of the present invention;

FIG. 15 shows an image format table corresponding to the formats of input image data according to the first embodiment of the present invention;

FIG. 16 shows an image format table corresponding to the formats of output image data according to the first embodiment of the present invention;

FIG. 17 shows an MLB table according to the first embodiment of the present invention;

FIG. 18 is a sequence diagram showing the operation of acquiring the format information according to the first embodiment of the present invention;

FIG. 19 shows the respective MLB image format tables of multi-function apparatuses according to the first embodiment of the present invention;

FIG. 20 is an MLB table formed of the MLB tables of the multi-function apparatuses according to the first embodiment of the present invention;

FIG. 21 is an image format (input) table formed of the image format (input) tables of the multi-function apparatuses according to the first embodiment of the present invention;

FIG. 22 is an image format (output) table formed of the image format (output) tables of the multi-function apparatuses according to the first embodiment of the present invention;

FIG. 23 is a flowchart of the operation of selecting a slave unit to which image data is transferred and determining the transfer-time format of the image data to be transferred according to the first embodiment of the present invention;

FIG. 24 is a flowchart of the operation of selecting a slave unit and determining the transfer-time format of image data to be transferred according to the first embodiment of the present invention;

FIG. 25 is a screen diagram showing a list of multi-function apparatuses on the network according to the first embodiment of the present invention;

FIG. 26 is a flowchart of the operation of determining the grade of each multi-function apparatus on the network according to the first embodiment of the present invention;

FIG. 27 shows a connected image evaluation table according to the first embodiment of the present invention;

FIG. 28 is a flowchart of the operation of determining the transfer-time format of image data in the case of transferring the image data with high image quality according to the first embodiment of the present invention;

FIG. 29 shows a conversion format table according to the first embodiment of the present invention;

FIG. 30 is a flowchart of the operation of determining the transfer-time format of image data in the case of transferring the image data with less than high image quality according to the first embodiment of the present invention;

FIG. 31 shows a conversion format table according to the first embodiment of the present invention;

FIG. 32 is a flowchart of the operation of transferring image data according to the first embodiment of the present invention;

FIG. 33 is a block diagram for illustrating a software configuration of the SCS according to a second embodiment of the present invention;

FIG. 34 is a flowchart of the operation of generating format information according to the second embodiment of the present invention;

FIG. 35 is a flowchart of the operation of transferring image data according to the second embodiment of the present invention;

FIG. 36 is a flowchart of the operation of determining the transfer-time format of image data according to the second embodiment of the present invention;

FIG. 37 shows a transfer mode setting screen according to the second embodiment of the present invention; and

FIG. 38 is a flowchart of the operation of determining the transfer-time format of image data on the transfer mode setting screen according to the second embodiment of the present invention.

### DETAILED DESCRIPTION OF THE PREFERRED EMBODIMENTS

A description is given below, with reference to the accompanying drawings, of embodiments of the present invention.

In a first embodiment, a first apparatus is connected to a second apparatus via a communication part, and when the first apparatus is activated, the first apparatus acquires format information from the second apparatus, the format information including an image data format that the second apparatus can support. In a second embodiment, a first apparatus is connected to a second apparatus via a communication part, and when the first apparatus transfers image data to the second apparatus, the first apparatus acquires format information from the second apparatus, the format information including an image data format that the second apparatus can support.

In both embodiments, multi-function apparatuses are employed. The software and hardware configurations of each multi-function apparatus in the first embodiment are equal to those in the second embodiment. Accordingly, a description of the software and hardware configurations of each multi-function apparatus is omitted in the second embodiment.

[First Embodiment]

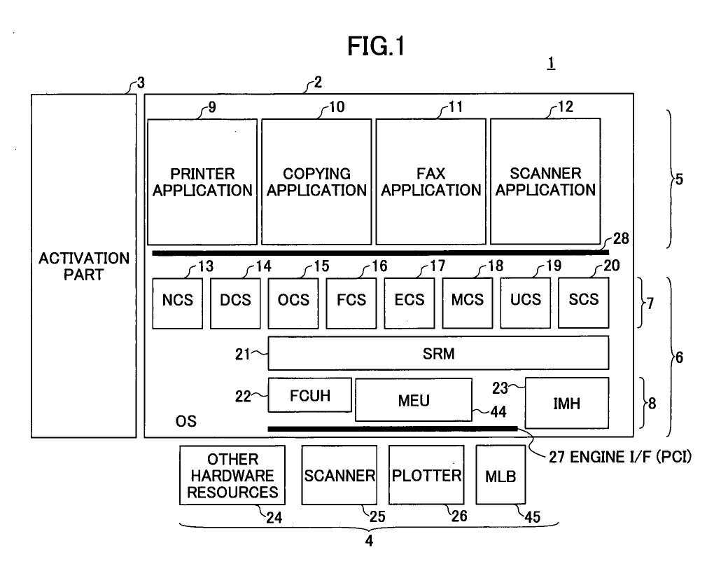

FIG. 1 is a block diagram showing a configuration of a multi-function apparatus 1 according to the first embodiment. The multi-function apparatus 1 includes a software group 2, an activation part 3, and hardware resources 4.

When the multi-function apparatus 1 is turned on, the activation part 3 operates first so as to activate an application layer 5 and a platform layer 6. For instance, the activation part 3 reads out programs of the application layer 5 and the platform layer 6 from a hard disk drive (HDD), and transfers each read-out program to a memory area to activate the read-out programs. The hardware resources 4 include a scanner 25, a plotter 26, a media link board (MLB) 45 corresponding to an image data conversion part, and other hardware resources 24 such as a facsimile machine. The MLB 45 performs high-speed conversion of an image data format by hardware.

The software group 2 includes the application layer 5 and the platform layer 6 activated on an operating system (OS) such as UNIX®. The application layer 5 includes programs performing processing specific to image formation-related user services such as printing, copying, facsimile communication, and scanning.

The application layer 5 includes a printer application 9 for printing, a copying application 10 for copying, a facsimile (FAX) application 11 for facsimile communication, and a scanner application 12 for scanning.

The platform layer 6 includes a control service layer 7, a system resource manager (SRM) 21, and a handler layer 8. The control service layer 7 interprets a request for processing (a processing request) from the application layer 5, and generates an acquisition request to acquire the requested one of the hardware resources 4. The SRM 21 manages at least one of the hardware resources 4 and arbitrates between acquisition requests from the control service layer 7. The handler layer 8 manages the hardware resources 4 in accordance with the acquisition requests from the SRM 21.

The control service layer 7 is adapted to include one or more service modules such as a network control service (NCS) 13, a delivery control service (DCS) 14, an operations panel control service (OCS) 15, a facsimile control service (FCS) 16, an engine control service (ECS) 17, a memory control service (MCS) 18, a user information control service (UCS) 19, and a system control service (SCS) 20.

The platform layer 6 is adapted to include an application program interface (API) 28 that makes a processing request from the application layer 5 receivable by a predefined function. The OS executes the software programs of the application layer 5 and the platform layer 6 in parallel as processes.

The NCS 13, which corresponds to a communication part, provides applications requiring a network I/O with a service that can be used in common by the applications. The NCS 13 mediates in distributing data received from the network side based on respective protocols to applications and transmitting data from applications to the network side.

For instance, the NCS 13 controls data communications with a network apparatus connected via a network to the multi-function apparatus 1 by HTTP (HyperText Transfer Protocol) using an HTTPd (HyperText Transfer Protocol Daemon).

The DCS 14 controls distribution of stored documents. The OCS 15 controls an operations panel serving as an information communication part between an operator and main body control. The FCS 16 provides an API for facsimile transmission from and facsimile reception by the application layer 5 using a PSTN or ISDN network, for instance, registration and citation of a variety of facsimile data managed in a backup memory, reading of facsimile data, and printing of received facsimile data.

The ECS 17 controls the engine parts of the scanner 25, the plotter 26, and the other hardware resources 24. The MCS 18 performs the memory control operations of acquiring and releasing memory and using an HDD, for instance. The UCS 19 manages user information.

The SCS 20 performs processing such as applications management, operation part control, system screen display, LED display, hardware resource management, and interrupting application control.

The SRM 21 controls the system and manages the hardware resources 4 in cooperation with the SCS 20. For instance, the process of the SRM 21 performs arbitration and execution control according to an acquisition request from a higher layer for the use of any of the hardware resources 4 such as the scanner 25 and the plotter 26.

Specifically, the SRM 21 determines whether the requested one of the hardware resources 4 is available, that is, whether the requested one of the hardware resources 4 is being used by another acquisition request. If the requested one of the hardware resources 4 is available, the SRM 21 notifies the higher layer that the requested one of the hardware resources 4 is available. Further, in response to the acquisition request from the higher layer, the SRM 21 performs scheduling for using the requested one of the hardware resources 4, and directly carries out the contents of the request such as paper feeding and image forming by a printer engine, memory reservation, and file creation.

The handler layer 8 includes a facsimile control unit handler (FCUH) 22, an image memory handler (IMH) 23, and a media edit utility (MEU) 44. The FCUH 22 manages a below-described facsimile control unit (FCU) 40. The IMH 23 allocates memory to each process and manages the memory allocated to each process. The SRM 21 and the FCUH 22 make processing requests to the hardware resources 4 using an engine I/F (interface) 27 (peripheral component interconnect [PCI]) that makes the processing requests to the hardware resources 4 transmittable by a predefined function. The MEU 44 converts the image data format using the MLB 45. The MEU 44 can also convert the image data format by software.

The multi-function apparatus 1 can perform all necessary operations common to the applications in the platform layer 6. Next, a description is given of the hardware configuration of the multi-function apparatus 1.

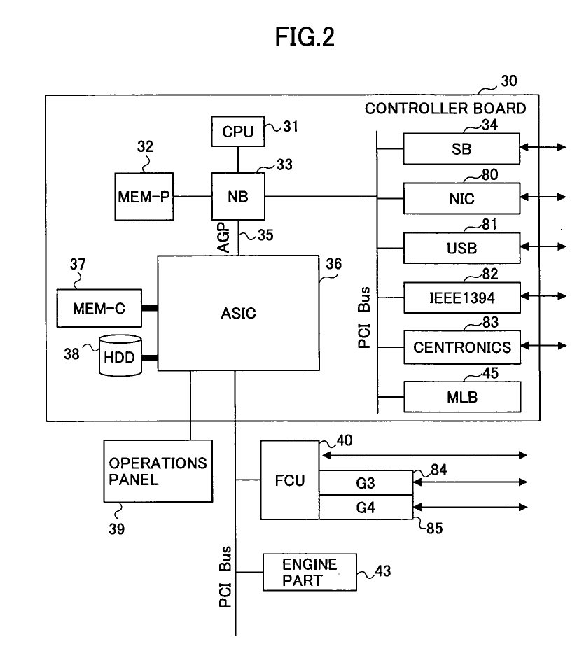

FIG. 2 is a block diagram showing a hardware configuration of the multi-function apparatus 1 according to the first embodiment. The multi-function apparatus 1 includes a controller board 30, an operations panel 39, the FCU 40, a G3 standard-compliant unit 84, a G4 standard-compliant unit 85, and an engine part 43.

The controller board 30 includes a CPU 31, a system memory (MEM-P) 32, a Northbridge (NB) 33, a Southbridge (SB) 34, an ASIC (Application Specific Integrated Circuit) 36, a local memory (MEM-C) 37, an HDD 38, a network interface card (NIC) 80, a USB device 81, an IEEE 1394 device 82, a Centronics device 83, and the MLB 45.

The operations panel 39 is connected to the ASIC 36 of the controller board 30. The FCU 40 and the engine part 43 are connected to the ASIC 36 of the controller board 30 via a PCI bus.

In the controller board 30, the local memory 37 and the HDD 38 are connected to the ASIC 36, and the CPU 31 is connected to the ASIC 36 via the NB 33 of a CPU chipset. Thus, the CPU 31 can be connected to the ASIC 36 via the NB 33 even if the interface of the CPU 31 is not open to the public.

The ASIC 36 and the NB 33 are connected not via a PCI bus but via an accelerated graphics port (AGP) 35. In order to execute and control one or more processes forming the application layer 5 and the platform layer 6, the ASIC 36 and the NB 33 are thus connected not via a low-speed PCI bus but via the AGP 35, thereby preventing a decrease in performance.

The CPU 31 controls the entire multi-function apparatus 1. The CPU 31 activates the NCS 13, the DCS 14, the OCS 15, the FCS 16, the ECS 17, the MCS 18, the UCS 19, the SCS 20, the SRM 21, the FCUH 22, and the IMH 23 on the OS as processes, and causes them to be executed. The CPU 31 also activates the printer application 9, the copying application 10, the fax application 11, and the scanner application 12 of the application layer 5 on the OS, and causes them to be executed.

The NB 33 is a bridge for connecting the CPU 31, the system memory 32, the SB 34, and the ASIC 36. The system memory 32 is employed as, for instance, the memory for image drawing of the multi-function apparatus 1. The local memory 37 is employed as an image buffer for copying and a code buffer. The SB 34 is a bridge for connecting the NB 33 with a PCI bus, a ROM, and peripheral devices.

The ASIC 36 is an IC for image processing including a hardware element for image processing. The HDD 38 is a storage device for storing image data, document data, programs, font data, and forms. The operations panel 39 is an operation part for receiving the operations input from the operator and displaying information to the operator.

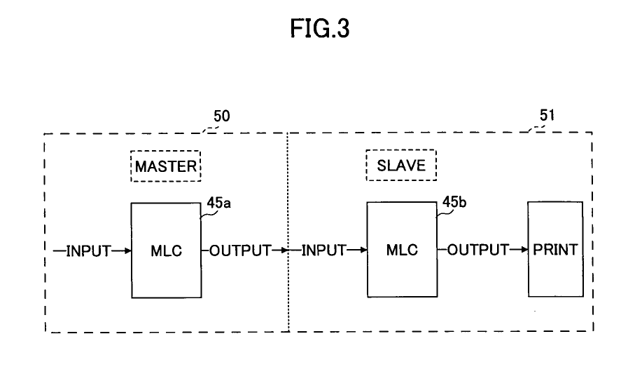

Next, a description is given of the operation of transferring image data (an image data transfer operation). For an easy understanding of the image data transfer operation, first, a description is given, with reference to FIG. 3, of the basic contents of the operation. FIG. 3 shows a master unit 50 that transfers image data and a slave unit 51 that receives the image data and performs printing based on the received image data. The master unit 50 includes an MLB 45a and the slave unit 51 includes an MLB 45b. The master unit 50 and the slave unit 51 are not predetermined. A unit that transmits image data is a master unit and a unit that receives the image data is a slave unit.

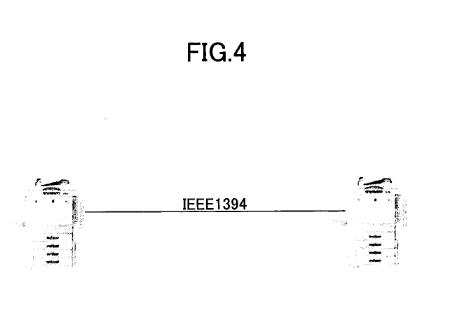

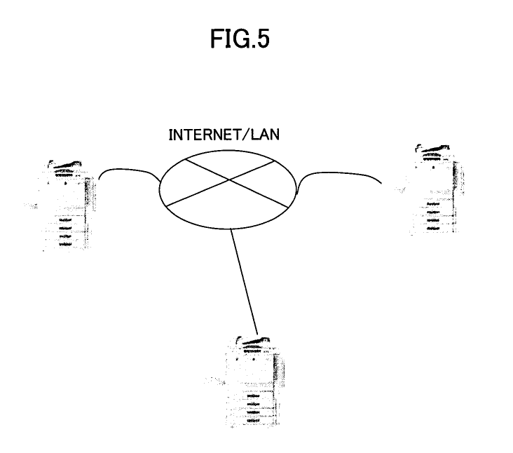

The master unit 50 and the slave unit 51 may be connected in compliance with, for instance, the IEEE 1394 standard as shown in FIG. 4. Alternatively, the master unit 50 and the slave unit 51 may be connected via a twisted pair cable. Further, the master unit 50 and the slave unit 51 may also be connected via the Internet or a LAN as shown in FIG. 5. That is, the master unit 50 and the slave unit 51 may be connected using any protocol.

A description is given of the operations of the master unit 50 and the slave unit 51 thus connected. Referring to FIG. 3, the master unit 50 acquires from the connected slave unit 51 format information including an image data format that can be supported by the slave unit 51. Next, based on the capability of the slave unit 51, the master unit 50 determines the image data format with which image data input by copying is to be transferred. This image data format may be referred to as a transfer-time format (of image data), or a format of image data at the time of transferring the image data, which format is obtained by converting an input or initial format of the image data. Then, the master unit 50 converts the format of the image data in the MLB 45a, and transfers the image data to the slave unit 51. The slave unit 51, receiving the image data, converts the image data in the MLB 45b and performs printing based on the received image data.

Thus, the master unit 50 acquires from the connected slave unit 51 format information including an image data format supportable by the slave unit 51, determines the transfer-time format of image data to be transferred to the slave unit 51 based on the acquired format information, and converts the format of the image data in the MLB 45a in accordance with the determined transfer-time format of the image data.

Meanwhile, the slave unit 51 generates the format information including the image data format supportable by the slave unit 51, and supplies the generated format information to the connected master unit 50. Further, the slave unit 51 converts the image data received from the master unit 50 in accordance with the received format of the image data in the MLB 45b.

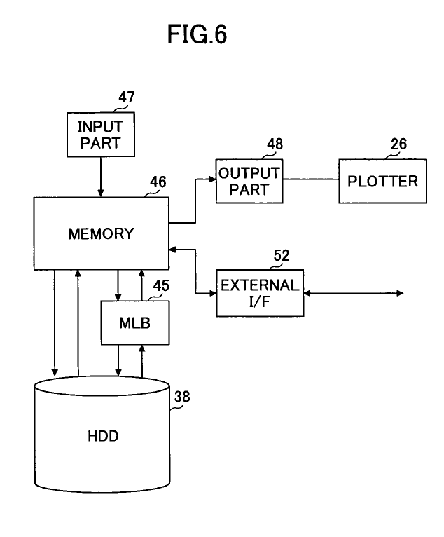

Next, a description is given of the details of the above-described operations. First, a description is given, with reference to FIG. 6, of the flow of image data in the multi-function apparatus 1 and a related configuration thereof. The configuration of FIG. 6 includes an input part 47, a memory 46, the MLB 45, the HDD 38, an output part 48, the plotter 26, and an external I/F 52.

The input part 47 inputs the image data of a copier, a facsimile machine, or the scanner 25. The memory 46 stores the input image data and the image data received from the external I/F 52. Either the system memory (MEM-P) 32 or the local memory (MEM-C) 37 is employed as the memory 46. The HDD 38 also stores the input image data and the image data received from the external I/F 52. The MLB 45 converts the format of the image data stored in the memory 46 or the HDD 38. The plotter 26 is a printing part that performs printing based on the image data acquired from the output part 48. The external I/F 52 connects the multi-function apparatus 1 with such a network as described above.

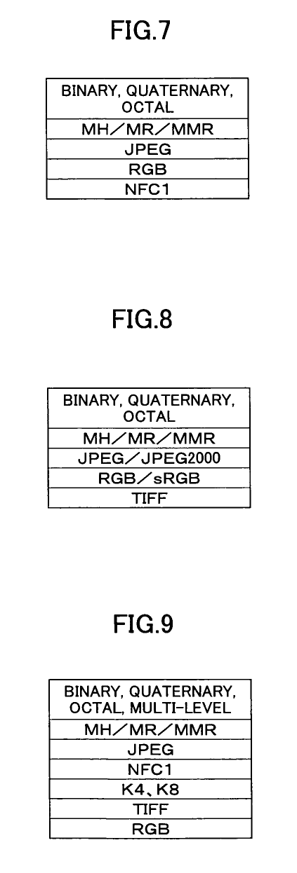

Next, a description is given of the formats of image data input from the input part 47. Referring to FIG. 7, the formats of image data input from the input part 47 include binary, quaternary, octal, MH/MR/MMR, JPEG, RGB, and NFC1. NFC1 is a compression format.

The image data input from the input part 47 or the external I/F 52 is first read into the memory 46 and then stored in the HDD 38 directly from the memory 46 or after being converted in the MLB 45.

Next, a description is given of formats of image data convertible in the MLB 45. Referring to FIG. 8, the formats of image data convertible in the MLB 45 include binary, quaternary, octal, MH/MR/MMR, JPEG/JPEG2000, RGB/sRGB, and TIFF, for example. The MLB 45 converts the format of image data by hardware, so that the conversion is performed at high speed.

Next, a description is given of formats of image data storable in the HDD 38. Referring to FIG. 9, the formats of image data storable in the HDD 38 include binary, quaternary, octal, multi-level, MH/MR/MMR, JPEG, NFC1, K4, K8, TIFF, and RGB, for example. K4 and K8 are compression formats.

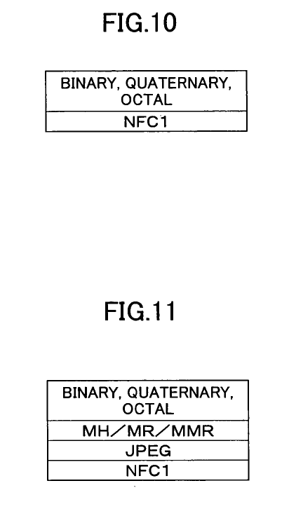

Next, a description is given of the formats of image data output to the plotter 26. Referring to FIG. 10, the formats of image data output from the output part 48 to the plotter 26 include binary, quaternary, octal, and NFC1, for example.

Next, a description is given of the formats of image data transmitted from or received by the external I/F 52. Referring to FIG. 11, the formats of image data transmitted from or received by the external I/F 52 include binary, quaternary, octal, MH/MR/MMR, JPEG, and NFC1, for example.

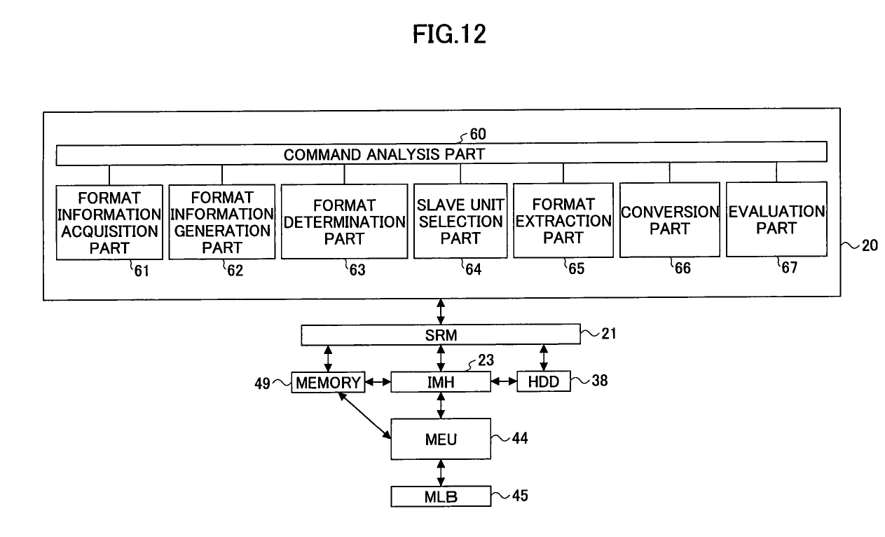

Next, a description is given, with reference to FIG. 12, of a software configuration of the SCS 20. FIG. 12 is a block diagram for illustrating a software configuration of the SCS 20. In FIG. 12, software blocks that are not related to this embodiment are omitted.

FIG. 12 shows the SCS 20, the SRM 21, a memory 49, the IMH 23, the HDD 38, the MEU 44, and the MLB 45.

Referring to FIG. 12, the SCS 20 includes a command analysis part 60, a format information acquisition part 61, a format information generation part 62, a format determination part 63, a slave unit selection part 64, a format extraction part 65, a conversion part 66, and an evaluation part 67.

The command analysis part 60 analyzes the commands (instructions) of information input from another module, a higher application, or the network, and allocates the information to an appropriate one of the parts 61 through 67. The format information acquisition part 61 acquires from a connected multi-function apparatus format information including an image data format supportable by the connected multi-function apparatus. The format information is described in detail below.

The format information generation part 62 generates the format information. The format determination part 63 determines the format of image data to be transferred to the connected multi-function apparatus based on the format information acquired therefrom. The slave unit selection part 64, corresponding to an apparatus selection part, selects one or more from connected multi-function apparatuses. The format extraction part 65 extracts a particular format from the format information.

The conversion part 66, corresponding to an image data conversion part, converts the format of image data by the SRM 21, the IMH 23, and the MEU 44 in accordance with the transfer-time format determined by the format determination part 63. The evaluation part 67 evaluates each multi-function apparatus from which the format information has been acquired based on the acquired format information.

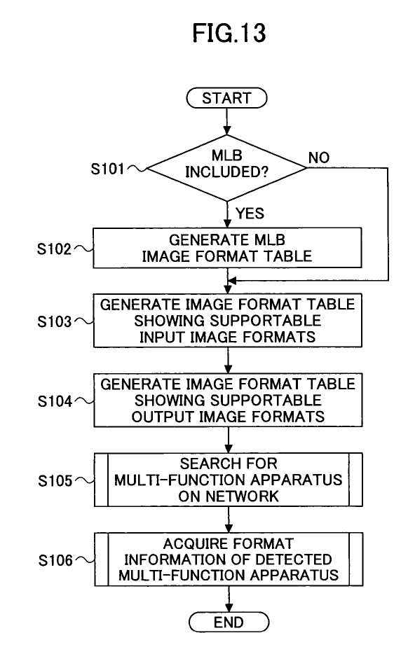

Next, a description is given of the operation of the SCS 20 performed according to the above-described configuration. First, a description is given, with reference to the flowchart of FIG. 13, of the operation of generating format information which operation is performed at the time of activating the multi-function apparatus 1.

This operation includes roughly two operations. One is the generation of image format tables, and the other is the acquisition of format information. Accordingly, in the description of this flowchart, the steps up to the generation of the image format tables are described first, and then, after describing the image format tables, the acquisition of the format information is described.

Referring to FIG. 13, in step S101, the SCS 20 determines whether the multi-function apparatus 1 includes an MLB. If no MLB is included (that is, “NO” in step S101), the operation proceeds to step S103. If an MLB (the MLB 45) is included (that is, “YES” in step S101), in step S102, the SCS 20 generates a below-described MLB image format table.

Next, in step S103, the SCS 20 generates an image format table showing the formats of input image data supportable by the multi-function apparatus 1 when received from outside. Next, in step S104, the SCS 20 generates an image format table showing the formats of output image data that can be output from the multi-function apparatus 1.

Next, in step S105, the SCS 20 searches for a multi-function apparatus 1′ (having the same configuration as the multi-function apparatus 1) on the network. In step S106, corresponding to the step of acquiring format information, the SCS 20 acquires the format information of the multi-function apparatus 1′ detected by the search. Thus, the SCS 20 acquires the format information when the multi-function apparatus 1 is activated, and ends the operation.

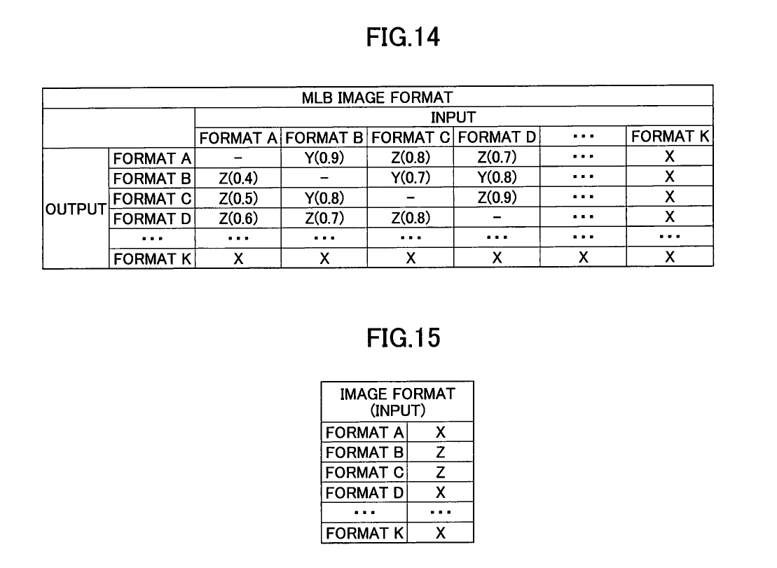

The image format tables are described below in the order mentioned above. FIG. 14 shows the MLB image format table. The table shows whether a conversion from one format to another is performable by the MLB 45. The MLB image format table also includes information on the compression rate of image data by each performable conversion and information as to whether each performable conversion is reversible.

Referring to FIG. 14, whether a conversion from one format to another is performable is indicated by “X,” “Y,” or “Z,” which is entered at the intersection (cell) of an input format and an output format in the table. In the table, “X” indicates that a conversion is not performable, “Y” indicates that a conversion is reversible, and “Z” indicates that a conversion is irreversible.

A parenthesized number in a cell of the table indicates a compression rate by the corresponding conversion.

For instance, if image data of a format A is input, and is output with a format B after format conversion, Z and (0.4) are shown at the intersection of the formats A and B. This shows that the conversion from the format A to the format B is irreversible and that its compression rate is 0.4. Further, the table of FIG. 14 also shows that a format K is convertible to no formats.

Thus, the format information includes information on formats convertible by the MLB 45. The format information also includes information on compression, that is, compression rates and information as to whether a conversion is reversible.

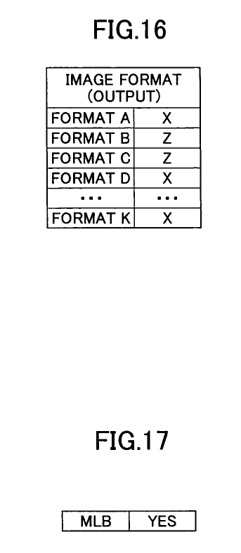

Next, a description is given, with reference to FIGS. 15 and 16, of the image format tables corresponding to the formats of input image data and the formats of output image data, respectively. FIG. 15 shows the image format table corresponding to the formats of input image data. FIG. 16 shows the image format table corresponding to the formats of output image data. In the tables of FIGS. 15 and 16, a format that can be input or output is indicated by “Z,” and a format that cannot be input or output is indicated by “X.” For instance, the image format table of FIG. 15 shows that it is possible to input a format C and that it is impossible to input the format K. Further, the image format table of FIG. 16 shows that it is possible to output the format B and that it is impossible to output a format D.

Thus, the format information includes information showing whether each image data format is supportable.

Next, a description is given, with reference to FIG. 17, of an MLB table. FIG. 17 shows the MLB table. The MLB table indicates the presence or absence of an MLB. When the multi-function apparatus 1 includes an MLB (the MLB 45), the MLB table indicates “YES” as shown in FIG. 17. If the multi-function apparatus 1 includes no MLB, the MLB table indicates “NO.” Thus, the format information includes information as to whether it is possible to convert the format of image data by the MLB 45. The MLB table is generated when the MLB image format table is generated.

The above-described tables of FIGS. 14 through 17 form the format information. The format information is thus generated so that it is easy to recognize from outside the multi-function apparatus 1 which image data format is supported by the multi-function apparatus 1.

A description is given of the significance of each of the image format tables of FIGS. 14 through 16. Generally, the multi-function apparatus 1 can support certain formats of image data without the MLB 45.

By including the MLB 45, however, the multi-function apparatus 1 can convert at higher speed a format of image data that is supportable without the MLB 45, and newly process a format of image data that is not supportable without the MLB 45.

Accordingly, in the case of converting the same image data format, the resulting image quality and the contents of processing differ between the case where the format is supportable by the image format tables of FIGS. 14 and 15 and the case where the format is supportable by only the image format table of FIG. 15. The same applies to the case where the format is supportable by only the image format table of FIG. 16. Therefore, the image format tables of FIGS. 14 through 16 are required. The image format tables of FIGS. 14 through 16 may be expressed by a single table by allocating individual symbols.

In the case of realizing the format information by a program written in C (programming language), the format information can be realized by causing “X,” “Y,” and “Z” to correspond to, for instance, 0x00, 0x01, and 0x02, respectively, and using arrays and bit-fields. This also applies to “YES” and “NO” in the MLB table of FIG. 17. As in the MLB image format table, a format may be correlated with two information items, that is, information as to whether the format is convertible and the compression rate of conversion, using C structures.

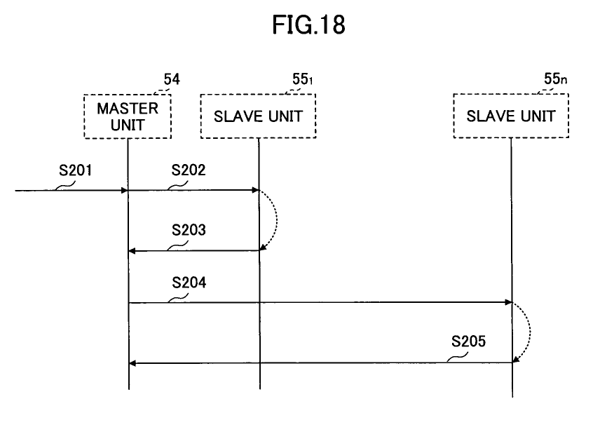

Next, a description is given, with reference to FIG. 18, of the communications between a master unit and a slave unit in the operation of acquiring the format information in step S106 of FIG. 13. FIG. 18 is a diagram showing a sequence of acquiring the format information. Referring to FIG. 18, in step S201, the SCS 20 of a master unit 54 receives a connection request from the operator. The connection request requests the master unit 54 to get connected to a selected slave unit for printing. The connection request is input through the operations panel 39 by the operator to be transmitted to the SCS 20 of the master unit 54.

Next, in step S202, the master unit 54 transmits a request for format information (a format information request) to a slave unit 55a. In step S203, the slave unit 55₁ supplies the format information generated at the time of its activation to the master unit 54. Likewise, in step S204, the master unit 54 transmits a format information request to a slave unit 55ₙ. In step S205, the slave unit 55ₙ supplies the format information generated at the time of its activation to the master unit 54. Thus, the master unit 54 acquires the format information, which is transmitted from the slave units 55₁ and 55n to the master unit 54 using a predetermined protocol.

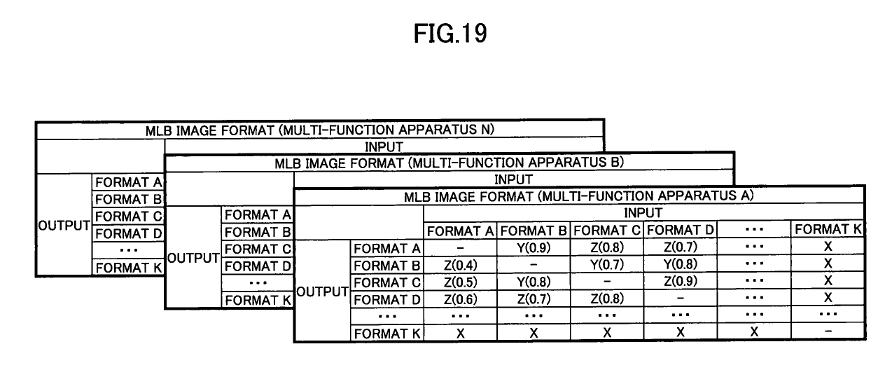

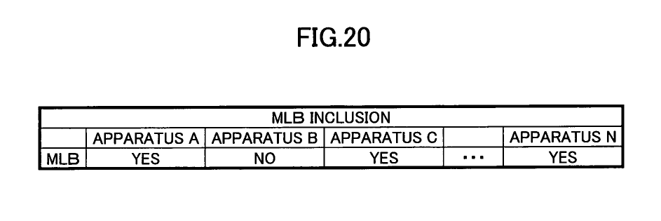

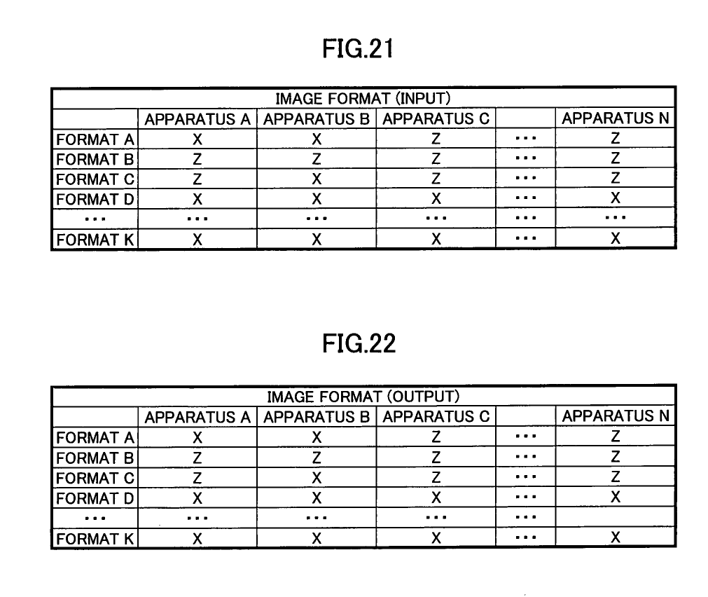

The acquired format information of each multi-function apparatus (slave unit) is stored independently in the master unit 54 as shown in FIGS. 19 through 22. FIG. 19 shows respective MLB image format tables of, for instance, multi-function apparatuses A through N. As shown in the table of FIG. 19, the MLB-related format information is formed of the MLB image format tables of the multi-function apparatuses A through N. Referring to FIG. 20, the MLB table is also formed of the MLB tables of the multi-function apparatuses A through N. Further, the image format table corresponding to the formats of input image data is formed of the image format tables corresponding to the formats of input image data of the multi-function apparatuses A through N as shown in FIG. 21, and the image format table corresponding to the formats of output image data is formed of the image format tables corresponding to the formats of output image data of the multi-function apparatuses A through N as shown in FIG. 22. Each of the image format tables of FIGS. 19 through 22 may be realized by a program forming the information corresponding to the multi-function apparatuses A through N into an array, using the information corresponding to each of the multi-function apparatuses A through N as a unit. Alternatively, each of the image format tables of FIGS. 19 through 22 may be realized by a program by reserving memory every time the format information is acquired from each of the multi-function apparatuses A through N and connecting the acquired format information by chains.

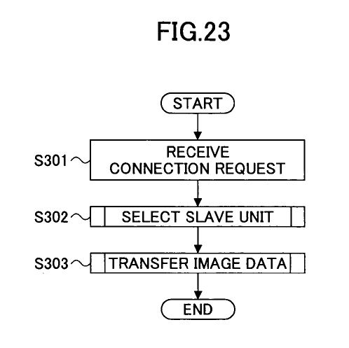

Next, a description is given, with reference to FIG. 23, of the operation of selecting a slave unit to which image data is transferred and determining the format of the image data to be transferred. FIG. 23 is a flowchart of the above-described operation.

Referring to FIG. 23, in step S301, the SCS 20 (of a master unit) receives a connection request. Next, in step S302, the SCS 20 performs the operation of selecting a slave unit (a slave unit selection operation). Then, in step S303, the SCS 20 performs the operation of transferring image data to the selected slave unit (an image data transfer operation).

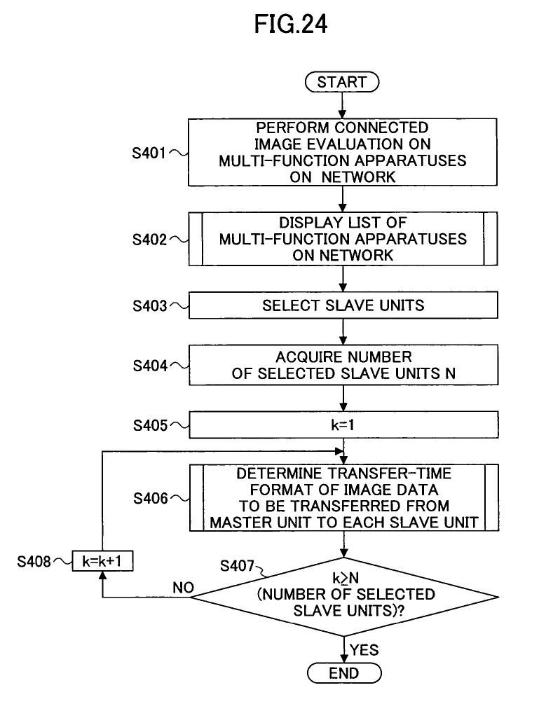

A detailed description is given of each of the above-described operations. First, a description is given, with reference to the flowchart of FIG. 24, of the slave unit selection operation of step S302.

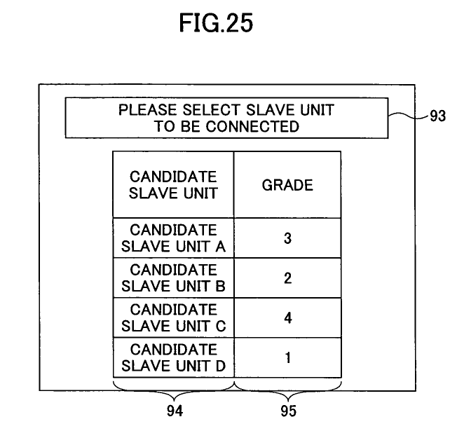

Referring to FIG. 24, in step S401, the SCS 20 evaluates the multi-function apparatuses on the network (connected image evaluation). The connected image evaluation is described below. In step S402, the SCS 20 displays a list of the multi-function apparatuses on the network on the operations panel 39. FIG. 25 is a diagram showing a screen of the displayed list of the multi-function apparatuses on the network. Referring to FIG. 25, the displayed list includes a message box 93, a candidate slave unit column 94, and a grade display column 95. The message box 93 is provided for displaying a message of “Please select a slave unit to be connected.” The candidate slave unit column 94 displays candidate slave units. The grade display column 95 displays the respective grades of the candidate slave units.

In step S403, the operator selects at least one of the displayed slave units. The grades are the results of individually evaluating the multi-function apparatuses (slave units) whose format information has been acquired based on the acquired format information. A description is given below of a method of obtaining the grades.

After the operator has selected one or more of the displayed slave units, in step S404, the SCS 20 acquires information as to which N slave units have been selected (N is the number of selected slave units). Then, in step S405, the SCS 20 initializes k, which is a loop counter employed in the following operation for counting the number of slave units, to one.

Next, in step S406, which corresponds to the step of determining a transfer-time format of image data, the SCS 20 determines the transfer-time format of image data to be transferred from the master unit to each slave unit. In step S407, the SCS 20 determines, based on whether or not k is greater than or equal to N, whether the transfer-time format of the image data has been determined for all the N slave units. If k is greater than or equal to N (that is, “YES” in step S407), it is determined that the transfer-time format of the image data has been determined for all the N slave units, and the SCS 20 ends the operation. If k is less than N (that is, “NO” in step S407), the SCS 20 has not determined the transfer-time format of the image data for all the N slave units. Therefore, in step S408, the SCS 20 increments k by one (k=k+1), and the SCS 20 performs the operation of step S406 again.

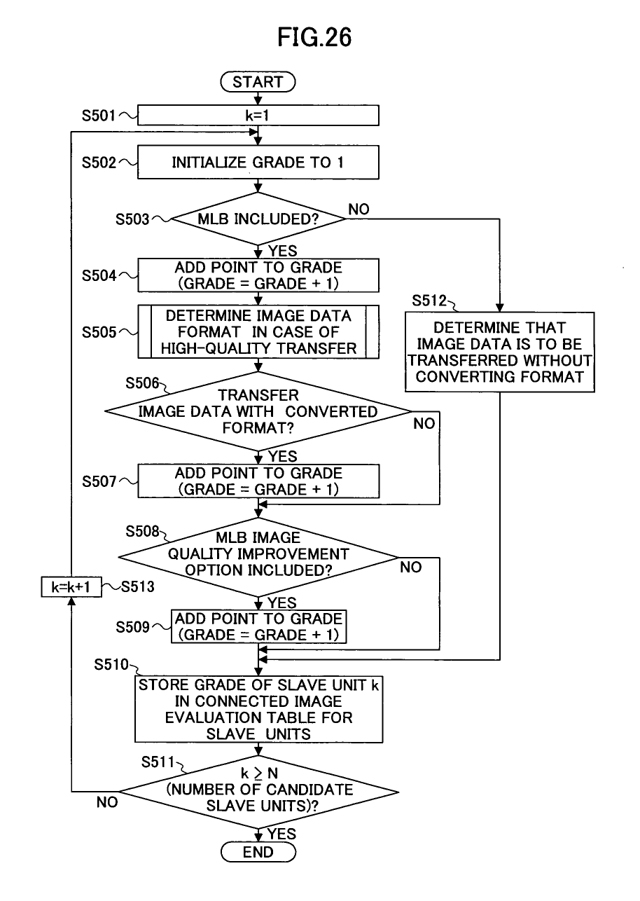

Next, a detailed description is given, with reference to the flowchart of FIG. 26, of the operation of the step S401. Referring to FIG. 26, in step S501, the SCS 20 initializes k, which is a loop counter employed for counting the number of slave units, to one. Next, in step S502, the SCS 20 initializes a grade coefficient GRADE employed for calculating the grade of a slave unit to one (GRADE=1).

In step S503, the SCS 20 determines whether a slave unit k includes an MLB (the MLB 45) based on the MLB table of FIG. 20. In the following description, the slave unit k refers to the k^{th} slave unit.

If the slave unit k includes no MLB (that is, “NO” in step S503), in step S512, the SCS 20 determines that the image data is to be transferred to the slave unit k without converting the format of the image data.

If it is determined in step S503 that the slave unit k includes an MLB (the MLB 45) (that is, “YES” in step S503), in step S504, the SCS 20 adds a point to the grade coefficient GRADE (GRADE=GRADE+1). The point is added because a variety of formats can be supported and processing can be performed at high speed with the MLB 45.

Next, in step S505, the SCS 20 determines the transfer-time format of image data in the case of transferring the image data with high image quality. The transferring of image data with high image quality means the transferring of image data whose format has been converted by a reversible one of the conversion formats described with reference to FIG.

14. The term “high image quality” may also be defined so that the transferring of image data with high image quality includes the transferring of image data whose format has been converted by an irreversible conversion format if the resulting image quality by the conversion matches required image quality. A description is given below of the operation of determining the transfer-time format of image data in the case of transferring the image data with high image quality.

Next, in step S506, the SCS 20 determines whether the image data is to be transferred with the format of the image data being converted. In the case of transferring the image data with the converted format, in step S507, the SCS 20 adds a point to the grade coefficient (GRADE=GRADE+1). The point is added because in the case of transferring the image data with the converted format, the image data may be smaller in size so that the traffic of a transmission channel may be controlled by the smaller-size image data. If the format of the image data is not converted, step S507 is not performed.

Next, in step S508, the SCS 20 determines whether the MLB 45 of the slave unit k includes the optional function of improving image quality (an image quality improvement option). The MLB 45 includes the BASIC function of performing basic conversions. In addition to the BASIC function, the MLB 45 may have the image quality improvement option for improving image quality.

If the MLB 45 has the image quality improvement option (that is, “YES” in step S508), in step S509, the SCS 20 adds a point to the grade coefficient GRADE (GRADE=GRADE+1). The point is added because it is possible to improve image quality. If the MLB 45 does not include the image quality improvement option (that is, “NO” in step S508), step S509 is not performed.

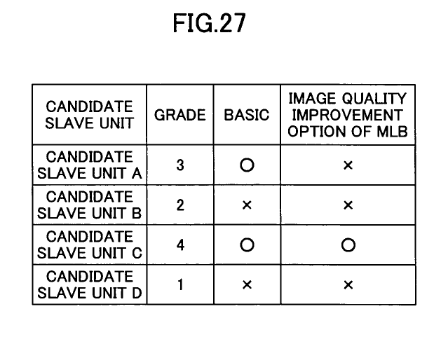

Thereafter, in step S510, the SCS 20 stores the grade coefficient of the slave unit k in a connected image evaluation table for the slave units. FIG. 27 is a diagram showing a connected image evaluation table. Referring to FIG. 27, in addition to the grades, the connected image evaluation table includes information as to whether the BASIC function is included and whether the image quality improvement option is included.

Next, in step S511, the SCS 20 determines, based on whether or not the loop counter k is greater than or equal to the number of candidate slave units N, whether the grades of all the candidate slave units have been calculated. If k is greater than or equal to N (that is, “YES” in step S511), the SCS 20 has evaluated all the N candidate slave units, and thus ends the operation. If k is less than N (that is, “NO” in step S511), the SCS 20 has not evaluated all the N candidate slave units. Therefore, in step S513, the SCS 20 increments k by one (k=k+1), and the SCS 20 performs the operation of step S502 again.

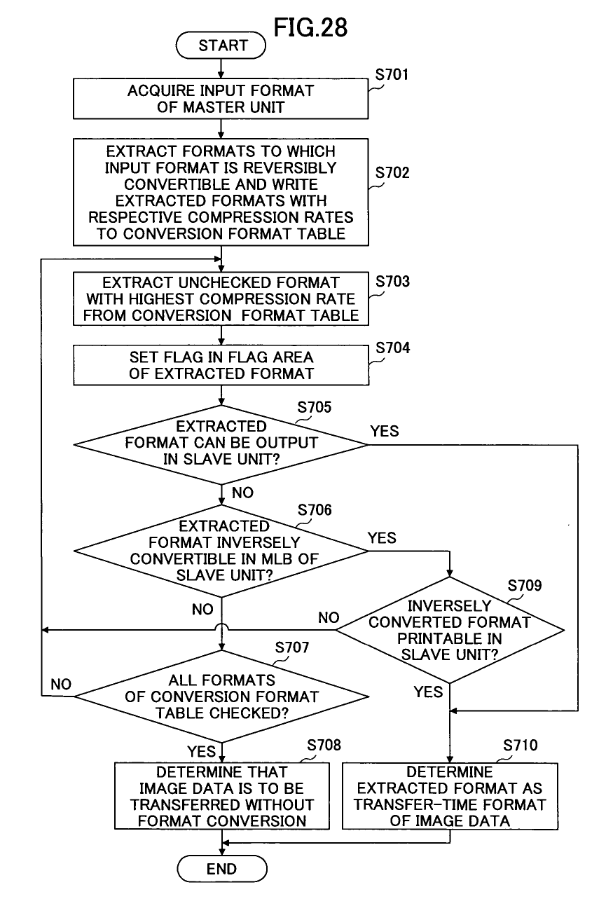

Next, a detailed description is given, with reference to the flowchart of FIG. 28, of the operation of determining the transfer-time format of image data in the case of transferring the image data with high image quality in step S505. In the following description, the input format of the master unit, which refers to the format of image data to be transferred from the master unit to a slave unit before conversion, is the format B for convenience of description.

Referring to FIG. 28, in step S701, the SCS 20 of the master unit acquires the input format of the master unit. Next, in step S702, the SCS 20 extracts, from the MLB image formats of the master unit (in this case, the MLB image formats shown in FIG. 14), formats (output image formats) to which the input format B is reversibly convertible, and writes the extracted output image formats and the corresponding compression rates to a conversion format table.

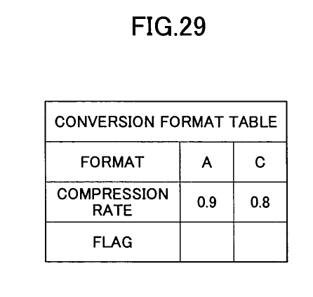

FIG. 29 shows the conversion format table. The table of FIG. 14 shows that the output formats to which the input format B is reversibly convertible are the formats A and C. Accordingly, the formats A and C are written to the conversion format table as shown in FIG. 29. The table of FIG. 14 also shows that their corresponding compression rates are 0.9 and 0.8, respectively. Accordingly, these values are written to the conversion format table.

Thus, from its format information, the SCS 20 determines (selects) the reversible compression formats as the formats of image data.

Referring back to FIG. 28, in step S703, the SCS 20 extracts one with the highest compression rate of those having no flag set in their respective flag areas of the formats written to the conversion format table. In the case of FIG. 29, the one with the highest compression rate is the format C. Accordingly, the format C is extracted. In step S704, the SCS 20 sets a flag in the flag area of the format C, indicating that the format C has been checked.

Thus, the SCS 20 determines a format with the highest compression rate of the acquired format information as the format of image data.

Next, in step S705, the SCS 20 determines whether the extracted format can be output in the slave unit. If the extracted format can be output in the slave unit (that is, “YES” in step S705), in step S710, the SCS 20 determines the extracted format as the transfer-time format of image data to be transferred, and then ends the operation.

If the extracted format cannot be output in the slave unit (that is, “NO” in step S705), in step S706, the SCS 20 determines whether the extracted format is inversely convertible in the MLB 45 of the slave unit. If the extracted format is inversely convertible (that is, “YES” in step S706), in step S709, the SCS 20 determines whether the format to which the extracted format is inversely converted in the slave unit is printable in the slave unit. If the format is printable in the slave unit (that is, “YES” in step S709), in step S710, the SCS 20 determines the extracted format as the transfer-time format of image data to be transferred to the slave unit, and then ends the operation. If the format is not printable in the slave unit (that is, “NO” in step S709), the SCS 20 again performs the operation of step S703.

Returning to step S706, if the extracted format is not inversely convertible in the MLB 45 of the slave unit (that is, “NO” in step S706), in step S707, the SCS 20 determines whether all the formats of the conversion format table have been checked. If any of the formats remains unchecked (that is, “NO” in step S707), the SCS 20 returns to the operation of step S703. If the SCS 20 has checked all the formats of the conversion format table (that is, “YES” in step S707), in step S708, the SCS 20 determines that the image data is to be transferred to the slave unit without converting the format (format conversion) of the image data.

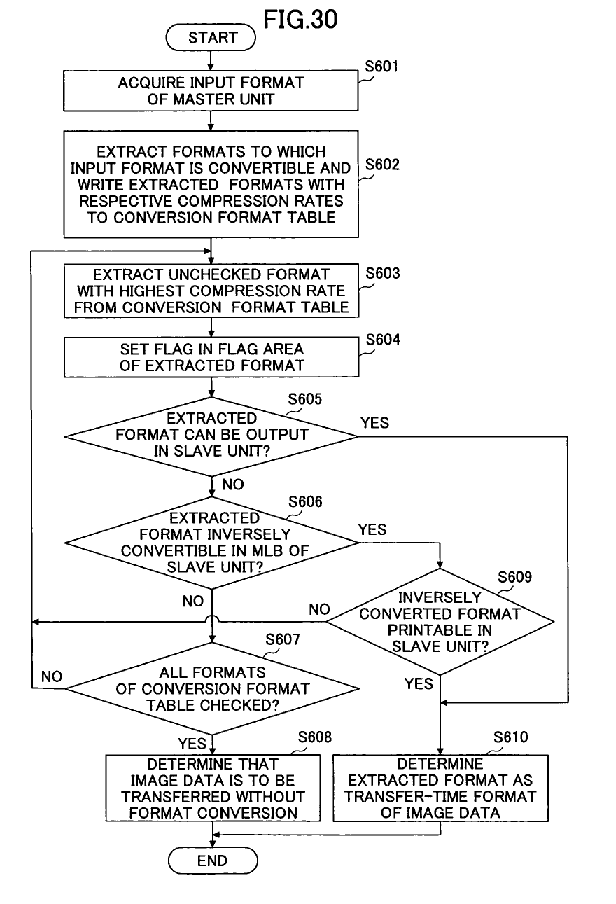

In the above-described operation, a format to which the input format is reversibly convertible is extracted in order to maintain image quality. If image quality is not a matter of concern, however, the operation of the flowchart of FIG. 30 may be performed as an alternative. A description is given of the operation of the flowchart of FIG. 30. In the following description, the input format of the master unit is also the format B for convenience of description.

Referring to FIG. 30, in step S601, the SCS 20 of the master unit acquires the input format of the master unit. Next, in step S602, the SCS 20 extracts, from the MLB image formats shown in FIG. 14, formats (output image formats) to which the input format B is convertible, and writes the extracted output image formats and the corresponding compression rates to the conversion format table.

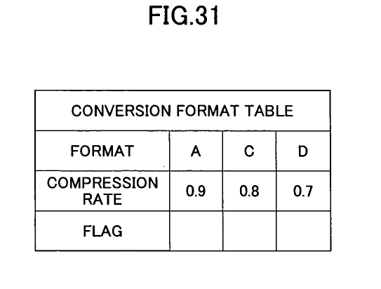

A description is given, with reference to FIG. 31, of the conversion format table in this case. First, referring to FIG. 14, the formats to which the input format B is convertible are the formats A, C, and D. Accordingly, the formats A, C, and D are written to the conversion format table as shown in FIG. 31. The table of FIG. 14 also shows that their corresponding compression rates are 0.9, 0.8, and 0.7, respectively. These values are also written to the conversion format table.

Referring back to the flowchart of FIG. 30, in step S603, the SCS 20 extracts one with the highest compression rate of those having no flag set in their respective flag areas of the formats written to the conversion format table. In the case of FIG. 31, the one with the highest compression rate is the format D. Accordingly, the format D is extracted. In step S604, the SCS 20 sets a flag in the flag area of the format D, indicating that the format D has been checked.

Thus, the SCS 20 determines a format with the highest compression rate, from the acquired format information, as the format of image data. As a result, the size of the image data becomes smaller so that the transfer efficiency may be increased and the traffic of a transmission channel may be controlled.

Next, in step S605, the SCS 20 determines whether the extracted format can be output in the slave unit. If the extracted format can be output in the slave unit (that is, “YES” in step S605), in step S610, the SCS 20 determines the extracted format as the transfer-time format of image data to be transferred, and then ends the operation.

If the extracted format cannot be output in the slave unit (that is, “NO” in step S605), in step S606, the SCS 20 determines whether the extracted format is inversely convertible in the MLB 45 of the slave unit. If the extracted format is inversely convertible (that is, “YES” in step S606), in step S609, the SCS 20 determines whether the format to which the extracted format is inversely converted in the slave unit is printable in the slave unit. If the format is printable in the slave unit (that is, “YES” in step S609), in step S610, the SCS 20 determines the extracted format as the transfer-time format of image data to be transferred to the slave unit, and then ends the operation. If the format is not printable in the slave unit (that is, “NO” in step S609), the SCS 20 again performs the operation of step S603.

Returning to step S606, if the extracted format is not inversely convertible in the MLB 45 of the slave unit (that is, “NO” in step S606), in step S607, the SCS 20 determines whether all the formats of the conversion format table have been checked. If any of the formats remains unchecked (that is, “NO” in step S607), the SCS 20 returns to the operation of step S603. If the SCS 20 has checked all the formats of the conversion format table (that is, “YES” in step S607), in step S608, the SCS 20 determines that the image data is to be transferred as it is to the slave unit without being converted.

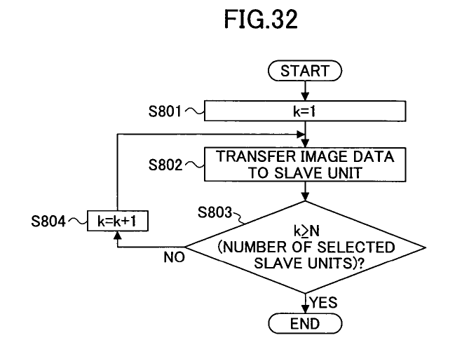

Thereby, the slave unit selection operation of step S302 of FIG. 23 ends. Next, a detailed description is given, with reference to the flowchart of FIG. 32, of the image transfer operation of step S303 of FIG. 23. First, in step S801, the SCS 20 of the master unit initializes k, which is a loop counter employed in the following operation for counting the number of slave units, to one. Next, in step S802, corresponding to the step of performing format conversion of image data to be transferred, the SCS 20 converts the format of the image data to the transfer-time format determined in step S302, and transfers the image data to the slave unit k.

Then, in step S803, the SCS 20 determines, based on whether or not k is greater than or equal to the number of selected slave units N, whether the image data has been transferred to all the selected slave units. If k is greater than or equal to N (that is, “YES” in step S803), the SCS 20 has transferred the image data to all the selected slave units. Therefore, the SCS 20 ends the operation. If k is less than N (that is, “NO” in step S803), the SCS 20 has not transferred the image data to all the selected slave units. Therefore, in step S804, the SCS 20 increments k by one (k=k+1), and then, the SCS 20 performs the operation of step S802 again.

[Second Embodiment]

Next, a description is given of the second embodiment of the present invention. The software and hardware configurations of the multi-function apparatus 1 according to the second embodiment are basically equal to those of the multi-function apparatus 1, described with reference to FIGS. 1 and 2, according to the first embodiment. Accordingly, a description thereof is omitted. In the second embodiment, the same elements as those of the first embodiment are referred to by the same numerals.

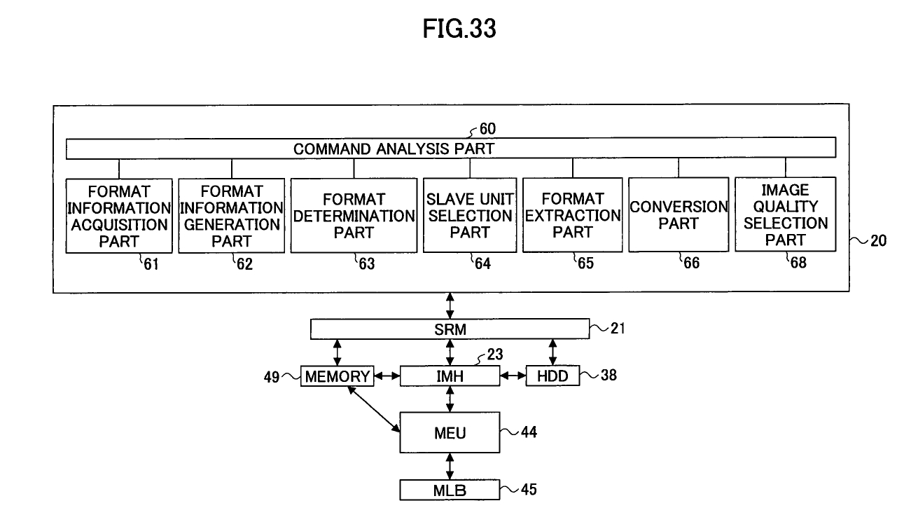

First, a description is given, with reference to FIG. 33, of a software block relating to image data communications that is not included in the software configuration of the SCS 20 of the first embodiment. FIG. 33 is a block diagram for illustrating a software configuration of the SCS 20 according to the second embodiment. FIG. 33 corresponds to FIG. 12 of the first embodiment. In the software blocks of the SCS 20 of FIG. 33, the only difference from those of the SCS 20 of FIG. 12 is an image quality selection part 68, which replaces the evaluation part 67 of the SCS 20 of the first embodiment. The image quality selection part 68 displays on the operations panel 39 a screen through which the operator determines whether to transfer image data with high image quality, and receives an input from the operator to reflect the received input in processing.

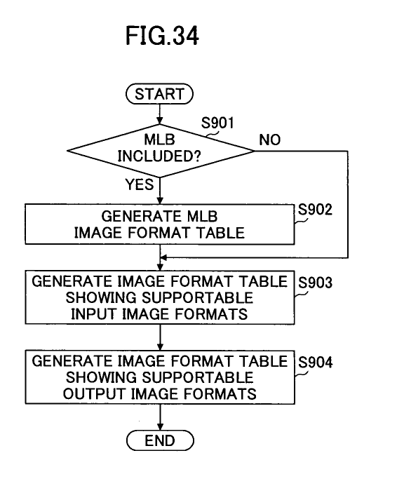

A description is given of an operation of the SCS 20 of the above-described configuration. First, a description is given, with reference to the flowchart of FIG. 34, of the operation of generating format information which operation is performed at the time of activating the multi-function apparatus 1.

Referring to FIG. 34, in step S901, the SCS 20 determines whether an MLB is included in the multi-function apparatus 1. If no MLB is included (that is, “NO” in step S901), the operation proceeds to step S903. If an MLB (the MLB 45) is included (that is, “YES” in step S101), in step S902, the SCS 20 generates the MLB image format table of FIG. 14.

Next, in step S903, the SCS 20 generates the image format table of FIG. 15. Next, in step S904, the SCS 20 generates the image format table of FIG. 16.

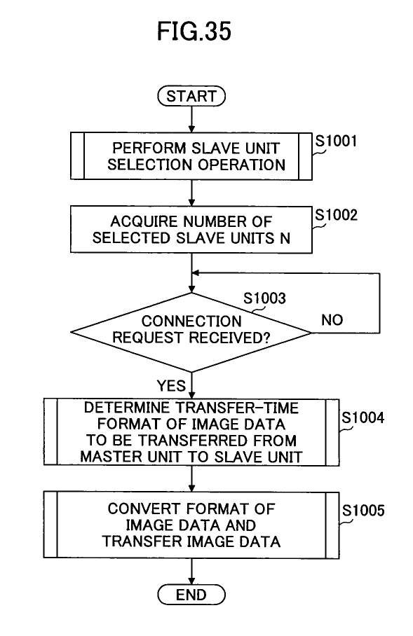

Next, a description is given, with reference to the flowchart of FIG. 35, of the operation of transferring image data. First, in step S1001, the operator performs the operation of selecting one or more slave units (multi-function apparatuses) to which image data is to be transferred (a slave unit selection operation). In step S1001, the operator may select one or more from the slave units displayed on the operations panel 39. Alternatively, the slave units may be assigned their respective IDs, and the operator may select one or more of the slave units by specifying their IDs. The device IDs, IP addresses, and MAC addresses of the multi-function apparatuses (slave units) may be employed as their IDs. Thus, the selecting of one or more slave units is performed by the input operation of the operator.

When the slave units are selected in step S1001, in step S1002, the SCS 20 of the master unit acquires information as to which N slave units have been selected (N is the number of selected slave units). Next, in step S1003, the SCS 20 is placed in a wait state until receiving a connection request from the operator. The connection request requests image data to be actually transferred from the master unit to a selected slave unit so that the selected slave unit may get connected to the master unit and perform printing. The connection request is input through the operations panel 39 to be reported to the SCS 20.

The SCS 20, receiving the connection request, requests and acquires format information from the selected slave units. This operation corresponds to the step of acquiring format information. Thus, when it is determined that the image data is to be transferred at the connection request of the operator, the SCS 20 requests format information from the multi-function apparatuses (slave units) to which the image data is to be transferred. The SCS 20 of each selected slave unit supplies its format information to the master unit.

Next, in step S1004, the SCS 20 determines (selects) the format of the image data to be transferred to each selected slave unit. Then, in step S1005, corresponding to the step of converting the format of image data to be transferred, the SCS 20 converts the format of the image data to the determined transfer-time format, and transfers the image data to the corresponding slave unit.

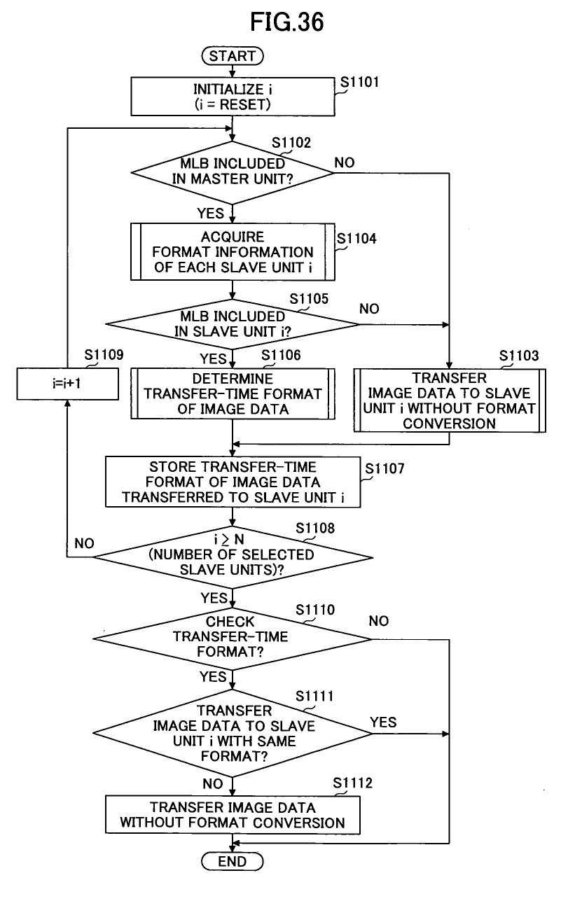

Next, an expatiation is given, with reference to the flowchart of FIG. 36, of the operation of step S1004 where the transfer-time format of image data is determined based on the acquired format information.

First, in step S1101 of FIG. 36, the SCS 20 of the master unit initializes i that is a loop counter employed for counting the number of slave units (i=RESET). Next, in step S1102, the SCS 20 determines whether an MLB is included in the multi-function apparatus (master unit) 1 in which the SCS 20 is provided. If no MLB is included (that is, “NO” in step S1102), in step S1103, the SCS 20 transfers image data without format conversion of the image data.

If an MLB (the MLB 45) is included in the master unit (that is, “YES” in step S1102), next, in step S1104, the SCS 20 acquires format information from each selected slave unit. The communications between the master unit and each selected slave unit in acquiring the format information is as described with reference to FIG. 18. The acquired format information of each selected slave unit is stored independently in the master unit as shown in FIGS. 19 through 22.

In step S1105, the SCS 20, based on the acquired format information, determines whether each slave unit i includes an MLB. This determination is performed based on the table shown in FIG. 20. If the slave unit i includes no MLB (that is, “NO” in step S1105), in step S1103, the SCS 20 transfers image data without converting the format of the image data.

If the slave unit i includes an MLB (the MLB 45) (that is, “YES” in step S1105), in step S1106, the SCS 20 determines (selects) the transfer-time format of image data. Then, in step S1107, the SCS 20 stores the determined format as the transfer-time format of the image data to be transferred to the slave unit i. In step S1108, the SCS 20 determines whether the transfer-time format of the image data has been determined for each slave unit i. If the SCS 20 has determined the transfer-time format of the image data for all the slave units i (that is, “YES” in step S1108), the SCS 20 proceeds to the operation of step S1110.

If the SCS 20 has not determined the transfer-time format of the image data for all the slave units i (that is, “NO” in step S1108), in step S1109, the SCS 20 increments the loop counter i by one (i=i+1), and again performs the operation of step S1102.

In step S1110, the SCS 20 determines whether to check the transfer-time format of the image data for each slave unit i. If the check is not required (that is, “NO” in step S1110), the SCS 20 ends the operation.

If the SCS 20 determines that the transfer-time format of the image data needs to be checked for each slave unit i (that is, “YES” in step S1110), in step S1111, the SCS 20 determines whether the image data is to be transferred to the slave unit i with the same format. If the image data is to be transferred to the slave unit i with the same format (that is, “YES” in step S1111), the SCS 20 ends the operation. If the image data is not to be transferred to the slave unit i with the same format, in step S1112, the SCS 20 determines that the image data is to be transferred without converting the format of the image data. Then, the SCS 20 ends the operation.

Thus, the format of image data to be transferred is determined. It is also possible to transfer image data with high image quality. The transferring of image data with high image quality means the transferring of image data whose format has been converted by a reversible one of the conversion formats described with reference to FIG. 14. The term “high image quality” may also be defined so that the transferring of image data with high image quality includes the transferring of image data whose format has been converted by a irreversible conversion format if the resulting image quality by the conversion matches required image quality.

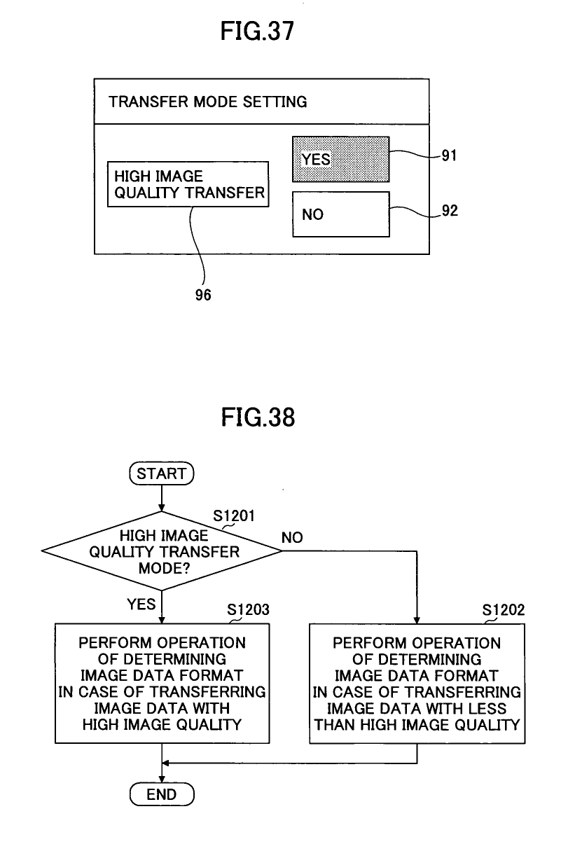

In the case of transferring image data with high image quality, the operator previously selects a high image quality transfer mode on the operations panel 39. FIG. 37 shows a screen that is displayed at this time. The screen has a text box 96 in which HIGH IMAGE QUALITY TRANSFER is displayed. This screen is a transfer mode setting screen on which the operator determines whether to transfer image data with high image quality by selecting a YES button 91 or a NO button 92. Image data is transferred with high image quality by the operator selecting the YES button 91 on this screen.

The detailed operation of step S1106 of FIG. 36 in this case is shown in FIG. 38. FIG. 38 is a flowchart of the operation of determining the format of image data to be transferred on the transfer mode setting screen. A description is given of the flowchart of FIG. 38.

First, in step S1201, the SCS 20 determines whether the high image quality transfer mode is selected. If the high image quality transfer mode is not selected (that is, “NO” in step S1201), in step S1202, the SCS 20 performs the operation of determining (selecting) the transfer-time format of image data in the case of transferring the image data with less than high image quality. Then, the SCS 20 ends the operation. If it is determined in step S1201 that the high image quality transfer mode is selected (that is, “YES” in step S1201), in step S1203, the SCS 20 performs the operation of determining (selecting) the transfer-time format of image data in the case of transferring the image data with high image quality. Then, the SCS 20 ends the operation.

The operation of determining the transfer-time format of image data in the case of transferring the image data with high image quality and the operation of determining the transfer-time format of image data in the case of transferring the image data with less than high image quality are shown in FIGS. 28 and 30, respectively.

The present invention is not limited to the specifically disclosed embodiments, and variations and modifications may be made without departing from the scope of the present invention.

The present application is based on Japanese priority applications No. 2002-314674, filed on Oct. 29, 2002, No. 2002-314675, filed on Oct. 29, 2002, and No. 2003-328199, filed on Sep. 19, 2003, the entire contents of which are hereby incorporated by reference.

What is claimed is:

1. An image-forming apparatus with a hardware resource used for image formation, a program for performing processing related to the image formation, and a communication part, the image-forming apparatus comprising:
a format information acquisition part that acquires format information from an apparatus connected to the image-forming apparatus via the communication part, the format information including information on a format of image data supportable by the connected apparatus;
a format determination part that determines a transfer-time format of image data to be transferred to the connected apparatus based on the acquired format information; and
an image data conversion part that performs format conversion of the image data to be transferred to the connected apparatus in accordance with the determined transfer-time format of the image data.

2. The image-forming apparatus as claimed in claim 1, further comprising an apparatus selection part that selects one or more from a plurality of apparatuses connected to the image-forming apparatus via the communication part.

3. The image-forming apparatus as claimed in claim 2, wherein said apparatus selection part selects the one or more apparatuses based on an input by an operator.

4. The image-forming apparatus as claimed in claim 2, wherein said apparatus selection part selects the one or more apparatuses based on information input to the image-forming apparatus.

5. The image-forming apparatus as claimed in claim 1, wherein said format information acquisition part acquires the format information by making a request to the connected apparatus for the format information.

6. The image-forming apparatus as claimed in claim 1, wherein said format information includes at least one of: information indicating, format by format, whether formats of image data are supportable by the connected apparatus; information on a format of image data convertible in the connected apparatus; information on compression of the convertible format of image data; and information as to whether the formats of image data are convertible by hardware in the connected apparatus.

7. The image-forming apparatus as claimed in claim 1, wherein said format information acquisition part stores the acquired format information based on a unit of the connected apparatus.

8. The image-forming apparatus as claimed in claim 1, wherein said format determination part determines a format of image data with the highest compression rate from the acquired format information as the transfer-time format of the image data to be transferred to the connected apparatus.

9. The image-forming apparatus as claimed in claim 1, wherein said format information acquisition part acquires the format information from the connected apparatus at a time of activation of the image-forming apparatus.

10. The image-forming apparatus as claimed in claim 9, further comprising an evaluation part that evaluates the connected apparatus independently based on the format information acquired therefrom.

11. The image-forming apparatus as claimed in claim 10, wherein a result of the evaluation by said evaluation part is displayed to an operator.

12. The image-forming apparatus as claimed in claim 10, wherein a result of the evaluation by said evaluation part is displayed on the image-forming apparatus.

13. The image-forming apparatus as claimed in claim 9, further comprising an evaluation part that evaluates each of apparatuses connected to the image-forming apparatus via the communication part independently based on the format information acquired therefrom.

14. The image-forming apparatus as claimed in claim 1, wherein said format determination part determines a reversible compression format from the acquired format information as the transfer-time format of the image data to be transferred to the connected apparatus.

15. The image-forming apparatus as claimed in claim 1, wherein said format information acquisition part acquires the format information from the connected apparatus at a time of transferring the image data thereto.

16. The image-forming apparatus as claimed in claim 15, wherein said format information acquisition part acquires the format information from the connected apparatus when an operator determines that the image data is to be transferred.

17. The image-forming apparatus as claimed in claim 15, further comprising an image quality selection part that determines whether to transfer the image data with high image quality to the connected apparatus.

18. The image-forming apparatus as claimed in claim 17, wherein said format determination part determines a reversible compression format from the acquired format information as the transfer-time format of the image data to be transferred to the connected apparatus when said image quality selection part determines that the image data is to be transferred with high image quality to the connected apparatus.

19. The image-forming apparatus as claimed in claim 15, further comprising an image quality selection part that selects a level of image quality at which the image data is transferred to the connected apparatus.

20. The image-forming apparatus as claimed in claim 15, wherein said format determination part determines whether to transfer the image data with a single format when the image data is to be transferred to a plurality of apparatuses connected to the image-forming apparatus via the communication part.

21. The image-forming apparatus as claimed in claim 20, wherein said format determination part transfers the image data to the connected apparatuses with the image data remaining unconverted when the image data is prevented from being transferred to the connected apparatuses with the single format.

22. The image-forming apparatus as claimed in claim 1, wherein the apparatus is connected to the image-forming apparatus through a network.

23. An image-forming apparatus with a hardware resource used for image formation, a program for performing processing related to the image formation, and a communication part, the image-forming apparatus comprising:
a format information generation part that generates format information including a format of image data supportable by the image-forming apparatus;
a format information supply part that supplies the generated format information to an apparatus connected to the image-forming apparatus via the communication part; and
an image data conversion part that converts image data received from the connected apparatus in accordance with a format of the received image data.

24. The image-forming apparatus as claimed in claim 23, wherein said format information includes at least one of: information indicating, format by format, whether formats of image data are supportable by the image-forming apparatus; information on a format of image data convertible in the image-forming apparatus; information on compression of the convertible format of image data; and information as to whether the formats of image data are convertible by hardware in the image-forming apparatus.

25. The image-forming apparatus as claimed in claim 23, wherein the apparatus is connected to the image-forming apparatus through a network.

26. An image data transfer method of an image-forming apparatus with a hardware resource used for image formation, a program for performing processing related to the image formation, and a communication part, the image data transfer method comprising the steps of:
(a) acquiring format information from an apparatus connected to the image-forming apparatus via the communication part, the format information including information on a format of image data supportable by the connected apparatus;
(b) determining a transfer-time format of image data to be transferred to the connected apparatus based on the acquired format information; and
(c) performing format conversion of the image data to be transferred to the connected apparatus in accordance with the determined transfer-time format of the image data.

27. The image data transfer method as claimed in claim 26, wherein said step (a) acquires the format information from the connected apparatus at a time of activation of the image-forming apparatus.

28. The image data transfer method as claimed in claim 26, wherein said step (a) acquires the format information from the connected apparatus at a time of transferring the image data thereto.

29. The image data transfer method as claimed in claim 26, wherein the apparatus is connected to the image-forming apparatus through a network.

30. A method of transferring image data between first and second image-forming apparatuses connected via a network, the method comprising the steps of:
(a) the first image-forming apparatus generating format information including a format of image data supportable by the first image-forming apparatus;
(b) the second image-forming apparatus acquiring the format information from the first image-forming apparatus via the network;
(c) the second image-forming apparatus determining a transfer-time format of image data to be transferred to the first image-forming apparatus via the network based on the acquired format information; and
(d) the second image-forming apparatus performing format conversion of the image data to be transferred to the first image-forming apparatus via the network in accordance with the determined transfer-time format of the image data.
